(19) United States
(12) Patent Application Publication
(10) Pub. No.: US 2026/0148627 A1
(43) Pub. Date: May 28, 2026

(54) STORAGE MEDIUM

(71) Applicant: TOYOTA JIDOSHA KABUSHIKI KAISHA, Toyota-shi (JP)

(72) Inventors: Keiko NAKANO, Kawasaki-shi (JP); Akira MIYAMOTO, Nisshin-shi (JP); Hajime MOMOHARA, Nagoya-shi (JP)

(73) Assignee: TOYOTA JIDOSHA KABUSHIKI KAISHA, Toyota-shi (JP)

(21) Appl. No.: 19/377,102

(22) Filed: Nov. 3, 2025

(30) Foreign Application Priority Data
Nov. 27, 2024 (JP) 2024-206727

(51) Int. Cl. G08B 21/06; B60W 40/08; G01C 21/34; G10L 15/08

(52) U.S. Cl. CPC G08B 21/06; B60W 40/08; G01C 21/34; G10L 15/08; B60W 2040/0827; G10L 2015/088

(57) ABSTRACT

A storage medium stores a program that causes a computer to perform operations including: acquiring an utterance made by a driver of a vehicle; determining whether a first phrase directly indicating fatigue of the driver is included in the utterance; when the first phrase is not included in the utterance, performing an estimation process of estimating whether the driver is fatigued based on the utterance; when the first phrase is included in the utterance, determining that the driver is fatigued without performing the estimation process; and when the driver is estimated or determined to be fatigued, outputting suggestion information that suggests a rest to the driver.

### CROSS-REFERENCE TO RELATED APPLICATION

This application claims priority to Japanese Patent Application No. 2024-206727 filed on Nov. 27, 2024. The disclosure of the above-identified application, including the specification, drawings, and claims, is incorporated by reference herein in its entirety.

### BACKGROUND

### 1. Technical Field

The present disclosure relates to storage media storing a program that estimates the driver's state of fatigue and suggests a rest to the driver based on the estimation result.

### 2. Description of Related Art

Conventionally, techniques are known for suggesting a rest to the driver based on the estimated state of fatigue.

For example, Japanese Unexamined Patent Application Publication No. 2014-013496 (JP 2014-013496 A) discloses a technique for suggesting a rest to the driver when the driver is within a predetermined distance from a service area (SA) or a parking area (PA) and is determined to be in a drowsy or fatigued state. In this technique, the determination of the drowsy or fatigued state is made using the degree of eye openness.

### SUMMARY

However, when the drowsy state is always measured by the same method as described in JP 2014-013496 A, a high processing load is placed on a central processing unit (CPU) etc. Therefore, a technique that reduces such processing load is desired. In addition, in conventional techniques such as those described above, it is necessary to implement dedicated processing for calculating the degree of fatigue based on signal information such as voice or camera data, which results in a high implementation difficulty.

A simpler method is to determine the need for rest based solely on driving duration. However, in such a case, the driver's condition such as the amount of sleep is often not considered, and the driver may feel uncomfortable because the suggestion does not reflect the driver's intention to rest.

The present disclosure provides a storage medium storing a program that appropriately addresses such issues, reduces processing load on a CPU etc., and enables rest suggestions to be made in accordance with the driver's intention.

A storage medium according to one embodiment of the present disclosure is a storage medium storing a program that causes a computer to perform operations including: acquiring an utterance made by a driver of a vehicle; determining whether a first phrase directly indicating fatigue of the driver is included in the utterance; when the first phrase is not included in the utterance, performing an estimation of whether the driver is fatigued based on the utterance; when the first phrase is included in the utterance, determining that the driver is fatigued without performing the estimation; and when the driver is estimated or determined to be fatigued, outputting suggestion information that suggests a rest to the driver.

The embodiment of the present disclosure enables rest suggestions to be made in accordance with the driver's intention, while reducing the processing load on the CPU etc., despite the simplicity of the implementation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating the present disclosure; and

FIG. 2 is a flowchart chart showing an example of the operation of the program.

### DETAILED DESCRIPTION OF EMBODIMENTS

Hereinafter, an embodiment will be described.

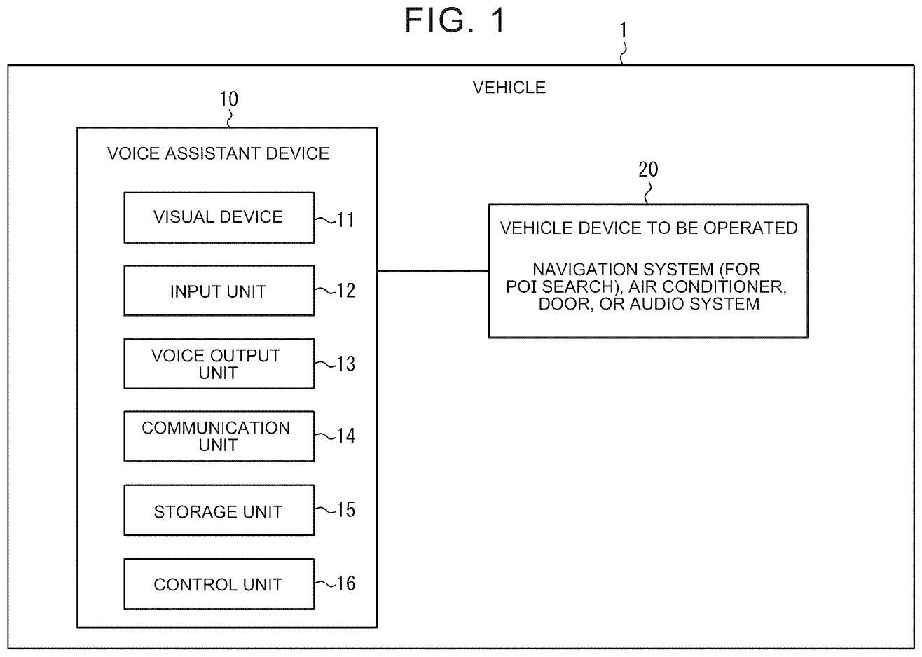

As shown in FIG. 1, the system according to the present embodiment includes, in a vehicle 1, a voice assistant device 10 and a vehicle device 20 to be operated. The voice assistant device 10 may be, for example, a voice assistant device in a navigation system mounted in a vehicle such as an automobile, a smartphone, or a tablet terminal. However, the voice assistant device 10 is not limited to these, and may be any device used by the user, as long as it is equipped with a voice assistant function. The vehicle device 20 to be operated is a device that is generally mounted in vehicles, such as a navigation system (e.g., for point-of-interest (POI) search), an air conditioner, a door, or an audio system.

First, a program according to an embodiment of the present disclosure acquires an utterance from the driver of the vehicle. Next, the program determines whether a first phrase directly indicating the driver's fatigue is included in the utterance.

When such a first phrase is included in the utterance, the program determines that the driver is fatigued, without estimating the driver's state of fatigue. In the present disclosure, phrases such as “I'm tired,” “My shoulders are stiff,” “I want to take a short break,” and “I'm sleepy” may be used as the first phrase. Such phrases may be modified as appropriate by adding or removing phrases to or from the voice assistant device 10 through training.

On the other hand, when the first phrase is not included in the utterance, an estimation process is executed to estimate whether the driver is fatigued based on the utterance. In this estimation process, it is possible to additionally estimate whether the driver is fatigued based on the utterance and the driving duration of the vehicle. The estimation may include a step of estimating that the driver is fatigued when a second phrase indirectly indicating the driver's fatigue is included in the utterance and the driving duration of the vehicle is greater than or equal to a predetermined threshold.

As described above, the program according to the embodiment of the present disclosure outputs suggestion information that suggests a rest to the driver when the driver is estimated or determined to be fatigued, and then terminates. The program is stored in a storage medium.

Next, the configurations of the components included in the system of the present disclosure will be described in detail.

As shown in FIG. 1, the voice assistant device 10 includes a visual device 11, an input unit 12, a voice output unit 13, a communication unit 14, a storage unit 15, and a control unit 16.

The visual device 11 may be a display for displaying information. The display may include, for example, a panel display that displays information on a display panel such as a liquid crystal panel or an organic electroluminescence (EL) panel. In the present embodiment, the visual device 11 primarily displays a map (image) included in a suggestion output from the control unit 16, but may also display a character string included in the suggestion output from the control unit 16.

The input unit 12 includes one or more input interfaces such as a microphone that receives voice input from the driver. The input unit 12 may also include a keyboard that receives character input and a touch panel provided integrally with the visual device 11.

The voice output unit 13 includes one or more speakers and plays voice suggestions output from the control unit 16.

The communication unit 14 includes one or more communication interfaces compatible with any desired communication standard. For example, the communication unit 14 may include communication interfaces compatible with mobile communication standards such as Fourth Generation (4G), wired Local Area Network (LAN) standards, wireless LAN standards, Controller Area Network (CAN) standards, and Universal Serial Bus (USB) standards.

The storage unit 15 includes one or more memories. In the present embodiment, the memory may include, for example, a semiconductor memory, a magnetic memory, or an optical memory. Each memory included in the storage unit 15 may function as, for example, a main storage device, an auxiliary storage device, or a cache memory. The storage unit 15 stores any data used in the operation of the voice assistant device 10 and data obtained through the operation of the voice assistant device 10. The storage unit 15 also stores the first phrase and the second phrase as utterance text.

The control unit 16 includes one or more processors, one or more programmable circuits, one or more dedicated circuits, or any combination thereof. The processor may be, for example, a general-purpose processor such as a central processing unit (CPU) or a graphics processing unit (GPU), or a dedicated processor specialized for specific processing, but is not limited to these. The programmable circuit may be, for example, a field-programmable gate array (FPGA), but is not limited to this. The dedicated circuit may be, for example, an application-specific integrated circuit (ASIC), but is not limited to this. The control unit 16 controls the overall operation of the voice assistant device 10.

In addition, the vehicle device 20 to be operated is a device that is generally mounted in vehicles, such as a navigation system (e.g., for POI search), an air conditioner, a door, or an audio system.

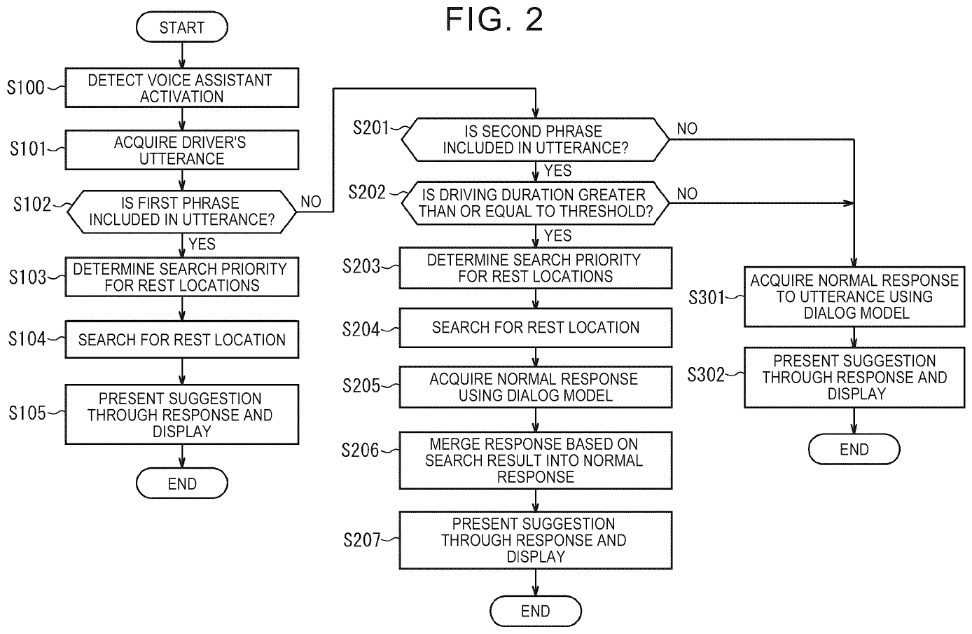

Next, the operation of the program according to this embodiment will be described with reference to FIG. 2.

FIG. 2 is a flowchart illustrating an example of the operation of the program according to the present embodiment. For example, each of the following steps is executed by the control unit 16 of the voice assistant device 10 in response to an instruction from the voice assistant device 10 operated by the driver.

In S100, the voice assistant device 10 detects an activation phrase for the voice assistant, and activates the components of the voice assistant device 10, including the control unit 16.

In S101, the input unit 12 of the voice assistant device 10 acquires the driver's utterance. In the present disclosure, to distinguish which utterance is from the driver, for example, a microphone (input unit 12) of the voice assistant device 10 may be installed at each seat to identify which seat occupant made the utterance.

In S102, the control unit 16 converts the driver's utterance acquired in S101 into utterance text, compares the utterance text with a preset first phrase, and determines whether the first phrase is included in the utterance text. When the first phrase is included in the utterance text (S102—Yes), the process proceeds to S103. Otherwise (S102—No), the process proceeds to S201. Examples of the first phrase include “I'm tired,” “My shoulders are stiff,” “I want to take a short break,” “I'm sleepy,” and “I want to take a break now.” However, the first phrase is not limited to these, and any phrase that directly indicates the driver is fatigued may be set as the first phrase.

In S103, the control unit 16 may determine what types of locations to search for and in what order of priority. That is, the search may be performed under different search conditions depending on the first phrase. For example, the first phrase may be used to categorize the driver's fatigue level as follows: phrases such as “I'm tired,” “My shoulders are stiff,” and “I want to take a short break” may be categorized as indicating low-urgency fatigue, while phrases such as “I'm sleepy” and “I want to take a break now” may be categorized as indicating high-urgency fatigue. The search conditions may then be set according to such categories.

An example of such search conditions is that, when the vehicle is traveling on a highway, the search prioritizes nearby service areas (SAs) or parking areas (PAs). When the vehicle is traveling on an ordinary road and the fatigue is categorized as low urgency, the search may prioritize specific types of locations along the route (for example, prioritize coffee shops over convenience stores, and roadside rest stops over coffee shops). On the other hand, when the vehicle is traveling on an ordinary road and the fatigue is categorized as high urgency, the search may be performed for any location with parking space, regardless of the type of location. Such categorization may be modified as appropriate. For example, the phrase “I'm tired” may be reclassified as indicating high-urgency fatigue, or the fatigue categories may be further subdivided into four levels: low-urgency fatigue, high-urgency fatigue, low-urgency drowsiness, and high-urgency drowsiness. In the case of low-urgency drowsiness in this four-level categorization, the specific types of locations may be, for example, locations with ample parking.

In S104, the control unit 16 performs a POI search for a rest location using the vehicle device 20 to be operated, such as a navigation system, in accordance with the search conditions determined in step S103.

In S105, the control unit 16 presents a rest suggestion (through a response and/or a display) based on the search results from S104, using the visual device 11 and the voice output unit 13 as appropriate. An example of such a rest suggestion is “You've been driving for a while. I've found a place for you to take a break. There's a convenience store nearby. Shall I set it as a stop?” That is, a rest suggestion may be presented using voice and a map of the convenience store. After the suggestion is presented, the voice assistant is terminated.

In S201, it is preferable that the control unit 16 execute a first step of an estimation process for estimating whether the driver is fatigued based on the utterance. For example, when a second phrase indirectly indicating the driver's fatigue is included in the utterance (S201—Yes), the process proceeds to S202. On the other hand, when the second phrase indirectly indicating the driver's fatigue is not included in the utterance (S201—No), the process proceeds to S301. In this case, the estimation may be performed by checking whether the second phrase indirectly indicating the driver's fatigue is included in the utterance. Examples of the second phrases include: utterances made out of boredom (such as “I'm bored,” “Tell me something fun,” and “Let's play Rock Paper Scissors”); utterances related to changing comfort settings (such as “Turn down the air conditioner” and “Turn on the seat ventilation”); utterances related to ventilation (such as “Open the window a bit” and “Open the moonroof”); and utterances related to the audio system (turning on the audio or changing the audio source (such as “Play music” and “Change the music”)). Utterances that do not explicitly indicate fatigue but may be made when the driver is tired may also be selected as appropriate and converted in advance into utterance text to be used as the second phrases. Additionally, a condition such as the absence of utterances related to audio operations for a certain period of time may also be used as a check condition in the first step of the estimation process in place of the second phrase.

In S202, the control unit 16 preferably checks whether the driving duration is greater than or equal to a predetermined threshold, as a second step of the estimation process for estimating whether the driver is fatigued based on the utterance. When the driving duration is greater than or equal to the threshold (S202—Yes), it is estimated that the driver is fatigued, and the process proceeds to S203. On the other hand, when the driving duration is less than the threshold (S202—No), it is not estimated that the driver is fatigued, and the process proceeds to S301.

In S203, the control unit 16 may perform the search under the same search conditions as those used for low-urgency fatigue in S103. That is, when the vehicle is traveling on a highway, the search may prioritize nearby service areas (SAs) or parking areas (PAs). Alternatively, when the vehicle is traveling on an ordinary road, the search may prioritize specific types of locations along the route. When the fatigue categories are further subdivided into four levels, the search may be performed as appropriate with reference to the same search conditions as those used for low-urgency fatigue and low-urgency drowsiness in S103.

In S204, the control unit 16 performs a POI search for a rest location using the vehicle device 20 to be operated, such as a navigation system, in accordance with the search conditions determined in step S203.

In S205, the control unit 16 acquires normal response information using a dialog model.

The “normal response information” refers to information output by the dialog model as a response to the utterance acquired in S101. For example, when a phrase such as “Turn down the air conditioner” is included in the utterance acquired in S101, the dialog model may output normal response information such as “I'll lower the air conditioner temperature by one degree.” In the present disclosure, in S206, the control unit 16 may merge the result of the rest-location search performed in S204 into the normal response information acquired in S205.

In S207, the control unit 16 presents the merged result from S206 as a suggestion using the visual device 11 and the voice output unit 13 as appropriate. An example of such merging is “I'll lower the air conditioner temperature by one degree. By the way, would you like to take a short break? There's a convenience store nearby.” That is, the result of the rest-location search is merged into the normal response information, and the merged result is presented as a suggestion using voice and a map of the convenience store. After the suggestion is presented, the voice assistant is terminated.

In S301, the control unit 16 acquires the normal response information.

In S302, the control unit 16 presents the normal response information as a suggestion through a response and/or a display, using the visual device 11 and the voice output unit 13 as appropriate. After the suggestion is presented, the voice assistant is terminated.

As described above, the embodiment of the present disclosure has been described based on the drawings and examples. However, the configurations of the voice assistant device 10 and the vehicle device 20 to be operated, as shown in FIG. 1, may be implemented using known configurations without any particular issues. In other words, it will be readily understood by those skilled in the art that various modifications and alterations, including such configurations, can be made based on the entirety of the present disclosure. Accordingly, it should be noted that such modifications and alterations fall within the scope of the present disclosure. For example, the functions included in each means or step may be rearranged as appropriate provided that there is no logical inconsistency. A plurality of means or steps may also be combined into one, or a single means or step may be divided into multiple means or steps as appropriate. Examples of modifications in the present disclosure include skipping steps S205, S206 as needed, and increasing the number of specific types of locations to be searched for in S103 and S203 when the driving duration is excessively long. When steps S201, S202 have already been implemented, they may be executed using the AI or image processing technologies employed in that implementation.

What is claimed is:

1. A non-transitory storage medium storing a program that causes a computer to perform operations comprising:
acquiring an utterance made by a driver of a vehicle;
determining whether a first phrase directly indicating fatigue of the driver is included in the utterance;
when the first phrase is not included in the utterance, estimating whether the driver is fatigued based on the utterance;
when the first phrase is included in the utterance, determining that the driver is fatigued without performing the estimating; and
when the driver is estimated or determined to be fatigued, outputting suggestion information that suggests a rest to the driver.

2. The non-transitory storage medium according to claim 1, wherein the computer is configured to, when performing the estimating, estimate whether the driver is fatigued based on the utterance and driving duration of the vehicle.

3. The non-transitory storage medium according to claim 2, wherein the computer is further configured to, when performing the estimating, estimate that the driver is fatigued when a second phrase indirectly indicating the fatigue of the driver is included in the utterance and the driving duration of the vehicle is greater than or equal to a predetermined threshold.

4. The non-transitory storage medium according to claim 1, wherein the operations further include:
when the first phrase is not included in the utterance, acquiring response information indicating a response to the utterance using a dialog model; and
outputting the response information.

5. The non-transitory storage medium according to claim 1, wherein:
the operations further include, when the driver is determined to be fatigued, searching for a rest location having a parking area for the vehicle, using a search condition that varies according to the first phrase; and
the suggestion information that is output when the driver is determined to be fatigued includes information indicating one or more rest locations found through the searching.
